(19) United States
(12) Patent Application Publication
(10) Pub. No.: US 2025/0147885 A1
(43) Pub. Date: May 8, 2025

(54) ELECTRONIC DEVICE SUPPORTING WRITEBACK SKIPPING AND METHOD OF OPERATING THE SAME

(71) Applicant: SAMSUNG ELECTRONICS CO., LTD., SUWON-SI (KR)

(72) Inventors: MOONGYUNG KIM, Suwon-si (KR); YOUNGSIK EOM, Suwon-si (KR); EUIYEON WON, Suwon-si (KR); ARA CHO, Suwon-si (KR); DONGHYEON HAM, Suwon-si (KR)

(21) Appl. No.: 18/883,151

(22) Filed: Sep. 12, 2024

(30) Foreign Application Priority Data
Nov. 8, 2023 (KR) 10-2023-0153776

(51) Int. Cl. G06F 12/0808; G06F 12/02; G06F 12/0811

(52) U.S. Cl. CPC G06F 12/0808; G06F 12/0246; G06F 12/0811

(57) ABSTRACT

An electronic device including: a memory; and a processor connected to the memory and configured to execute at least one instruction, wherein the processor executes the at least one instruction to transmit indicator information to the memory, wherein the indicator information identifies one or more memory areas, among a plurality of memory areas included in the memory, where useless data is stored, and the memory skips a writeback for the one or more memory areas, in response to the indicator information.

### CROSS-REFERENCE TO RELATED APPLICATION(S)

This U.S. non-provisional application claims priority under 35 U.S.C. § 119 to Korean Patent Application No. 10-2023-0153776, filed on Nov. 8, 2023, in the Korean Intellectual Property Office, the disclosure of which is incorporated by reference herein in its entirety.

### TECHNICAL FIELD

Example embodiments of the present inventive concept relate to an electronic device that supports writeback skipping and a method of operating the same.

### DISCUSSION OF RELATED ART

A computer system generates and uses memory areas during the execution and processing of programs. Subsequently, the computer system may delete useless memory areas and repurpose these freed areas for other tasks. Since the data within the physical address range of these deleted memory areas is no longer needed, it can be discarded by software. This discarded data may be referred to as “useless data.”

However, the hardware is not aware when data has been discarded. As a result, if useless data still resides in a memory area in a “dirty” state, it may be written back to the main memory. Since the written-back data is useless, writeback for the useless data is generally considered unnecessary.

### SUMMARY

Example embodiments of the present inventive concept provide an electronic device that supports writeback skipping and a method of operating the same.

According to an example embodiment, there is provided an electronic device including: a memory; and a processor connected to the memory and configured to execute at least one instruction, wherein the processor executes the at least one instruction to transmit indicator information to the memory, wherein the indicator information identifies one or more memory areas, among a plurality of memory areas included in the memory, where useless data is stored, and the memory skips a writeback for the one or more memory areas, in response to the indicator information.

According to an example embodiment, there is provided a method of operating an electronic device, the method including: checking whether data stored in one or more memory areas, among a plurality of memory areas included in a memory, is useless data; and transmitting indication information associated with the one or more memory areas to the memory, based on the checking of the useless data, wherein the indicator information is used to skip a writeback for the one or more memory areas.

According to an example embodiment, there is provided an electronic device including: a first memory; a processor connected to the first memory and configured to execute at least one instruction; and a second memory, wherein the processor executes the at least one instruction to transmit indicator information to the memory, wherein the indicator information identifies one or more memory areas, among a plurality of memory areas included in the first memory, where useless data is stored, and the first memory skips a writeback to the second memory from the one or more memory areas, in response to the indication information.

### BRIEF DESCRIPTION OF THE DRAWINGS

The above and other features of the present inventive concept will be more clearly understood from the following detailed description, taken in conjunction with the accompanying drawings.

FIG. 1 is a diagram illustrating an electronic device according to example embodiments.

FIG. 2 is a diagram illustrating a memory hierarchy according to example embodiments.

FIG. 3 is a diagram illustrating a first memory according to example embodiments.

FIG. 4 is a flowchart illustrating a method of operating an electronic device according to example embodiments.

FIGS. 5 and 6 are diagrams illustrating an operation based on indicator information for invalidation according to example embodiments.

FIGS. 7 and 8 are diagrams illustrating an operation based on indicator information for invalidation according to example embodiments.

FIGS. 9, 10 and 11 are diagrams illustrating an operation based on indicator information for clearing dirty bits according to example embodiments.

FIG. 12 is a diagram illustrating a first memory according to example embodiments.

FIGS. 13, 14, 15 and 16 are diagrams illustrating an operation based on indicator information for setting a useless bit according to example embodiments.

FIG. 17 is a flowchart illustrating a method of operating an electronic device according to example embodiments.

FIG. 18 is a flowchart illustrating a method of operating an electronic device according to example embodiments.

FIG. 19 is a diagram illustrating an electronic device according to example embodiments.

### DETAILED DESCRIPTION OF THE EMBODIMENTS

Hereinafter, example embodiments of the present inventive concept will be described with reference to the accompanying drawings.

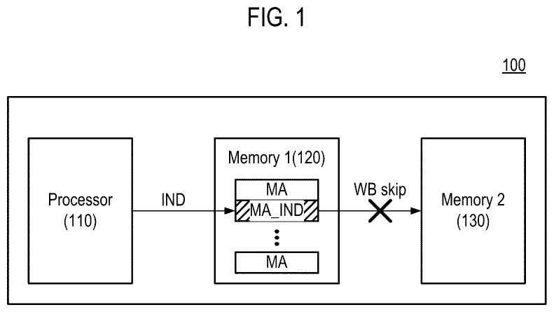

FIG. 1 is a diagram illustrating an electronic device according to example embodiments.

Referring to FIG. 1, an electronic device 100 according to example embodiments may include a processor 110, a first memory 120, and a second memory 130.

The processor 110 may be connected to the first memory 120 and/or the second memory 130 to control the first memory 120 and/or the second memory 130. The processor 110 may be configured to execute at least one instruction stored in the first memory 120 and/or the second memory 130, enabling it to implement descriptions, functions, procedures, proposals, methods, and/or operation flowcharts according to example embodiments. In addition, the processor 110 may execute operations based on instructions stored in the first memory 120 and/or the second memory 130, according to various embodiments. In addition, the processor 110 may process the information, stored in the first memory 120 and/or the second memory 130, to generate data.

According to example embodiments, each processor 110 may be a separate processor 110 or may be a core included in a multi-core processor. A multi-core processor may be a computing component including two or more independent processors 110, and each of the processors (or cores) may read and execute instructions.

According to example embodiments, the processor 110 may include one or more processing elements that may be symmetric or asymmetric. A processing element may refer to hardware or logic designed to support a software thread. Examples of hardware processing elements may include a thread unit, a thread slot, a thread, a process unit, a context, a context unit, a logical processor, a hardware thread, and a core. In other words, a processing element, may refer to any hardware capable of being independently associated with code, such as a software thread, operating system, application, or other codes.

According to example embodiments, the processor 110 may be implemented as a general-purpose processor, a specific-purpose processor, or an application processor (AP). For example, the processor 110 may be implemented as an operation processor (for example, a central processing unit (CPU), a graphics processing unit (GPU), or the like) including a specific-purpose logic circuit (for example, a field programmable gate array (FPGA), application specific integrated circuits (ASICs), or the like), but example embodiments are not limited thereto.

The first memory 120 and the second memory 130 may be connected to the processor 110, and may store various pieces of information related to the operation of the processor 110. For example, the first memory 120 and the second memory 130 may store a software code including at least one instruction for performing a portion or entirety of the processes or threads controlled by the processor 110, or for performing descriptions, functions, procedures, proposals, methods and/or operation flowcharts according to example embodiments. For example, the software code may be implemented in a procedural or object-oriented programming language, or may be implemented in assembly language or machine language. Alternatively, the software code may be implemented in a declarative programming language. However, example embodiments may not be limited to any specific programming language.

According to example embodiments, the first memory 120 may be a cache memory that stores either a portion of the entirety of data stored in other layers of memory or in secondary storage device such as a hard disk drive (HDD) or a solid state drive (SSD). The second memory 130 may be a main memory included in a lower layer of the first memory 120. A copy of data, including the at least one instruction stored in the second memory 130, may be stored in the first memory 120. Consequently, this can increase the access rate to the data stored in the second memory 130.

For example, each of the first memory 120 and the second memory 130 may be implemented as a volatile memory such as a dynamic random access memory (DRAM) or a static random access memory (SRAM).

The first memory 120 may be provided within the processor 110 according to example embodiments. The first memory 120 may include a plurality of memory areas MA for storing data. Each of the memory areas MA may be a unit of data transmitted between the first memory 120 and other layers of memory connected to a memory (for example, the second memory 130).

The first memory 120 may perform a write or read operation on data stored in the memory area MA in units of the memory areas MA. With regard to write operations, writethrough and writeback may be used as a write policy. The writethrough may be performed to update both data stored in the first memory 120 and data stored in other layers of memory during a write operation. The writeback may be performed to update only data stored in the first memory 120 during a write operation. Updates to data stored in other layers of memory may occur only during other operations that require writeback, such as a flush operation to clear a memory area MA or an eviction operation to replace an existing memory area MA with a new memory area MA.

The above-described write policy may ensure the coherency of the first memory 120. For example, in the case of writeback, a write operation may need to be performed only once on other layers of memory (for example, a lower memory) even if a write operation is repeated. Therefore, writeback may ensure the coherency of the first memory 120 while reducing performance degradation. However, when the stored data becomes useless data, an operation that requires the above-described writeback may still be transmitted to the memory. In this case, if the first memory, which is hardware, is not aware that the data is now useless, the writeback is automatically performed. This results in unnecessary writeback operations being executed.

Hereinafter, a description will be provided for various embodiments in which useless data, stored in a plurality of memory areas MA, are processed when the data stored in the plurality of memory areas MA becomes useless.

The processor 110 may run an application by executing a command for thread or process execution from software such as an application stored in the first memory 120 and/or the second memory 130.

The processor 110 may identify a memory allocation request based on the process or thread execution, and execute a memory allocation-related function. For example, the memory allocation-related function may be a memory allocation function such as malloc ( ) or new ( ) when a software code is implemented in an object-oriented programming language. Data allocated to a plurality of memory areas MA included in a memory may be present according to the memory allocation-related function.

The processor 110 may execute an allocation release-related function to release the memory allocated during an operation. For example, the allocation release-related function may be an allocation release function such as free ( ) or delete ( ) when a software code is implemented in an object-oriented programming language. When the processor 110 executes the allocation release-related function, the processor 110 may transmit indicator information IND to the first memory 120.

For example, when the allocated memory is released based on the allocation release-related function, data stored in the memory area MA may become data that is no longer needed, for example, useless data. Ultimately, the useless data may be data that results from the release of dynamic allocation for one or more memory areas MA_IND.

The memory area from which allocation has been released may be considered “destroyed.” In this case, data stored in the destroyed memory area may be regarded as useless data, which is no longer needed, and discarded. A memory area, in which useless data is present, does not have to be managed by hardware until the memory area is allocated again by software. However, to enhance performance, the useless data may still be retained in memory for potential reuse when the memory allocation is performed again. However, the memory, which is hardware, does not have the ability to determine whether the stored data is useless data. Therefore, according to example embodiments, the processor 110 may notify the memory whether the stored data is useless by transmitting, to the memory, the indicator information IND associated with one or more memory areas MA_IND, in which useless data is stored, among the plurality of memory areas MA included in the first memory 120.

In example embodiments, indicator information IND may be information about an address at which useless data is directly or indirectly stored. The indicator information IND may be a command to change data or a field included or stored in a memory area MA. An operation based on the indicator information IND may be performed in units of memory areas MA, and a memory area MA_IND associated with the indicator information IND may be considered as if it were removed from the management scope of the first memory 120. Example embodiments related to the indicator information IND will be described in detail later.

The first memory 120 may skip the above-described writeback for one or more memory areas MA_IND in which useless data is stored in response to the indicator information IND. For example, if the first memory 120 has already received the indicator information IND and subsequently receives a request for writeback from the processor 110, it may skip the writeback for one or more memory areas MA_IND, where useless data is stored.

According to the above-described embodiments, the electronic device 100 may prevent unnecessary writeback from occurring for useless data by transmitting the indicator information IND, which is information on the memory area MA where useless data is present, to a memory. As a result, the waste of memory performance may be reduced.

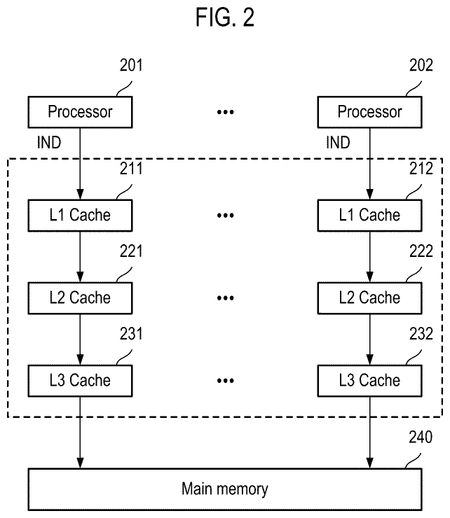

FIG. 2 is a diagram illustrating a memory hierarchy according to example embodiments.

As illustrated in FIG. 2, a memory hierarchy may include a plurality of processors 201 and 202, a plurality of cache memories 211, 212, 221, 222, 231 and 232 each having a memory area, and a main memory 240. In the case of a multi-core system, the plurality of processors 201 and 202 may correspond to a core.

The main memory 240 may store data used in the plurality of processors 201 and 202, and data stored in the main memory 240 may be copied to the plurality of cache memories 211, 212, 221, 222, 231 and 232. For example, the memory hierarchy may be a hierarchical cache structure. Thus, not only the main memory 240 but also cache memories any layer may read data from the main memory 240 or a lower-layer cache memory, and then store the read data. In this case, when a write operation is performed on the stored data, different layers of memory may have different values. Therefore, the above-described write policy may be used to ensure coherence.

In addition to the plurality of cache memories 211, 212, 221, 222, 231 and 232 illustrated in FIG. 2, more or fewer layers may be included in the hierarchy, according to example embodiments.

The hierarchical cache structures may include L1, L2, and L3 cache memories, starting with the highest level L1 cache memories 211 and 212 and followed by the lower-level L2 cache memories 221 and 222 and L3 cache memories 231 and 232. For example, the L1 level cache memories 211 and 212 may be private cache memories accessed exclusively by the plurality of processors 201 and 202. For example, the processor 201 may access the cache memory 211 and the processor 202 may not access the cache memory 211. Similarly, the processor 202 may access the cache memory 212 and the processor 201 may not access the cache memory 212. Furthermore, the L2 level cache memories 221 and 222 and the L3 level cache memories 231 and 232 may be shared cache memories accessed commonly by the plurality of processors 201 and 202. Depending on the type of implementation, a first portion of the L1 level to L3 level cache memories may be implemented as private cache memories, and a second portion of the L1 level to L3 level cache memories may be implemented as shared cache memories. However, the higher the memory's hierarchy, the more likely it is to be implemented with high-speed memory elements to enable quick data exchange with the plurality of processors 201 and 202 to achieve a shorter latency, or to be logically or physically disposed closer to the plurality of processors 201 and 202.

Data stored in the plurality of cache memories211, 212, 221, 222, 231 and 232 included in different layers may be written back to the main memory 240 (for example, to a lower layer) as required by the plurality of processors 201 and 202. However, when a portion of the data stored in the plurality of cache memories 211, 212, 221, 222, 231 and 232 becomes useless, writeback for the useless data may result in a performance drop.

In example embodiments, the plurality of processors 201 and 202 may transmit indicator information IND to the plurality of cache memories 211, 212, 221, 222, 231 and 232 to directly or indirectly identify a memory area where useless data is stored. As described above, the indicator information IND may be a command to change data or a field included or stored in a memory area, and the plurality of cache memories 211, 212, 221, 222, 231 and 232 may skip the writeback to the main memory 240 for useless data based on changes in the stored data or field.

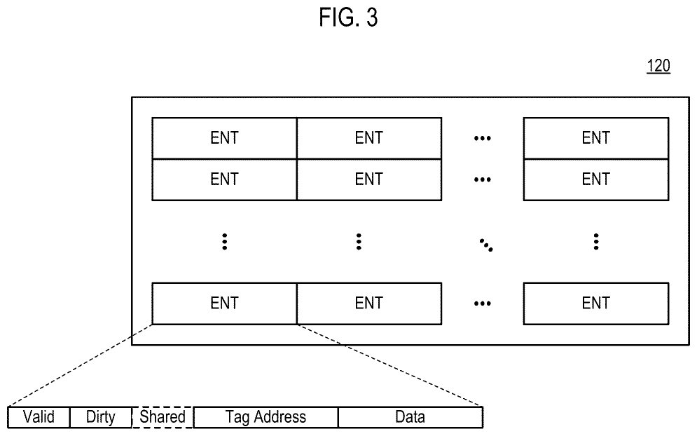

FIG. 3 is a diagram illustrating a first memory according to example embodiments.

Referring to FIG. 3, when the first memory 120 is implemented as a cache memory, the first memory 120 may include a plurality of cache entries ENT. The cache entry ENT may be generated when a data unit transferred between a cache memory and another level of cache memory or main memory, is copied to the cache memory. The data unit may be referred to as a cache line or a cache block. The cache entry ENT, the cache block, or the cache line may correspond to each of the above-described memory areas.

Each cache entry ENT may include a valid bit, a dirty bit, a shared bit, a tag address bit, and a data field. The valid bit may indicate whether each of the plurality of memory areas is valid. For example, the valid bit may indicate whether a data field has been loaded with valid data.

The dirty bit may indicate whether data stored in each of the plurality of memory areas has been modified. For example, a “dirty” state indicated by the dirty bit may be a state of data in a cache after data stored in the main memory is stored in the cache memory and updated or modified in the cache memory. A “clean” state indicated by the dirty bit may be a state of data in a cache excluding the “dirty” state (for example, a state of the data before being updated or modified). In other words, data may be in the “clean” state if it has not been updated or modified in the cache memory.

The share bit may indicate whether data stored in a corresponding cache entry ENT is shared between a plurality of processors. Depending on the type of implementation, the share bit may be omitted. The tag address bit may indicate an address of data fetched from the main memory. The data fetched from the main memory may be stored in a data field.

According to example embodiments, each bit included in a cache entry ENT may represent a specific state corresponding to the bit, depending on a specific logic to which the bit is set.

For example, the valid bit may be set to logic high to indicate that a corresponding cache entry ENT is valid, and set to logic low to indicate that the corresponding cache entry ENT is invalid. For example, the dirty bit may be set to logic high to indicate that data stored in a corresponding cache entry ENT is dirty, and set to logic low to indicate that the stored data is clean. For example, the share bit may be set to logic high to indicate that data stored in a corresponding cache entry ENT is shared between a plurality of processors, and set to logic low to indicate that the stored data is exclusive to a specific processor.

According to example embodiments, for example, at least one of the valid bit and dirty bit may be set to logic high or logic low based on indicator information. Therefore, the first memory 120 may skip the writeback of data stored in a specific cache entry ENT even if the data stored in the specific cache entry ENT becomes useless data, using the indicator information.

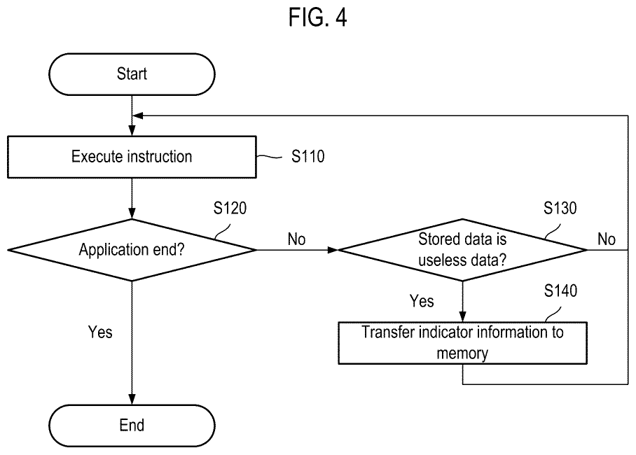

FIG. 4 is a flowchart illustrating a method of operating an electronic device according to example embodiments.

Referring to FIG. 4, an electronic device may run an application through a processor. In operation S110, the electronic device may execute an instruction based on the running application. As the instruction is executed, data may be stored in a second memory, and the data in the second memory may be copied to one or more memory areas included in a first memory.

In operation S120, the electronic device may terminate the application when the application needs to be terminated. When the application is still running, the flow proceeds to operation S130.

In operation S130, the electronic device may check whether the data stored in one or more memory areas included in the first memory is useless data. In example embodiments, the operation of checking whether the stored data is useless data may be performed depending on whether an allocation release-related function has been executed to release the allocation of a memory allocated by a processor. For example, the memory release-related function may include free ( ) delete ( ) or the like. According to the above-described embodiments, the electronic device may confirm that data stored in a memory area of an address corresponding to a memory release-related function has become useless data when the function is executed.

In operation S140, the electronic device may transmit indicator information associated with one or more memory areas to the first memory, based on the confirmation of the useless data. For example, the electronic device may transmit indicator information to the memory area, a target of the memory release-related function, when the memory release-related function is performed. The indicator information indicate that a writeback for one or more memory areas is to be skipped. Therefore, even if the first memory receives a request to writeback one or more memory areas, the writeback the one or more memory areas may be skipped. As a result, cache pollution caused by residual dirty data remaining after the frequent creation and destruction of an object due to memory allocation may be prevented.

Hereinafter, a description will be provided for various embodiments related to indicator information.

### Invalidation

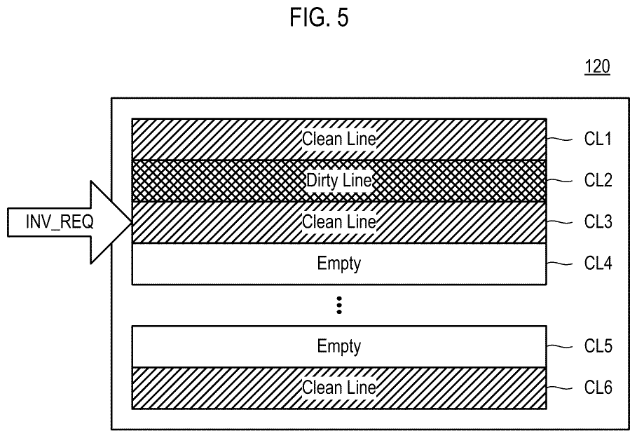

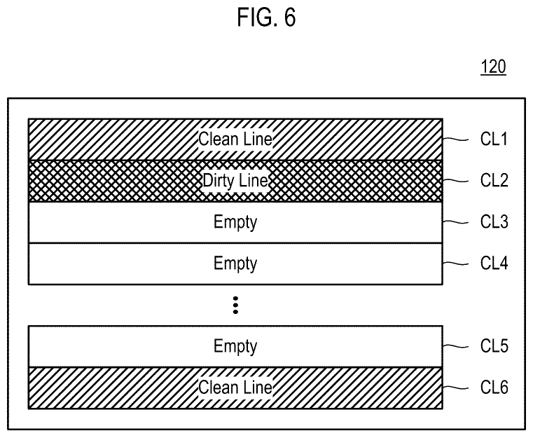

FIGS. 5 and 6 are diagrams illustrating an operation based on indicator information for invalidation according to example embodiments.

Referring to FIG. 5, data may be copied to a first memory 120 in units of a plurality of cache lines corresponding to a plurality of cache entries (see FIG. 3). For example, the plurality of cache lines may include a first cache line to an N-th cache line CL1, CL2, CL3, CL4, CL5 and CL6 (where N is a positive integer), and the first, third to N-th cache lines CL1, CL3 to CL6 may be in a clean state, whereas the second cache line CL2 may be in a dirty state. In addition, the fourth cache line CL4 and the N−1-th cache line CL5 may be in an empty state in which no data is stored.

An example is provided where data stored in the third cache line CL3 is updated or modified useless data. In this case, the third cache line CL3 may be storing useless data in a clean state, and a processor is not aware of a dirty or clean state of the data stored in the first memory 120. Therefore, the processor may transmit indicator information INV_REQ about a corresponding cache line to the first memory 120 regardless of the state of the dirty bit when the data is confirmed to be useless.

In this case, the indicator information INV_REQ may be set a valid bit included in one or more memory areas to logic low to indicate that one or more memory areas are invalid. For example, the indicator information INV_REQ may be used to invalidate the valid bit. The indicator information INV_REQ may enable the first memory 120 to exclude data and a tag address stored in a specific memory area from its management scope.

When a specific memory area is invalidated, it may be rendered empty. For example, when indicator information INV_REQ on the third cache line CL3 is received, the third cache line CL3 may be rendered empty as illustrated in FIG. 6. For example, the first memory 120 may remove the data, stored in the third cache line CL3 associated with the indicator information INV_REQ, to render the third cache line CL3 empty.

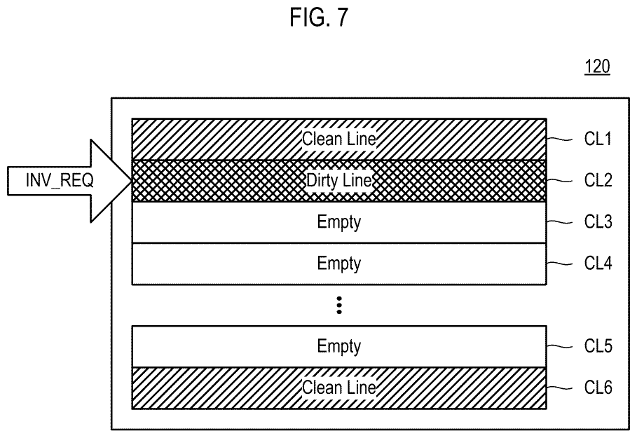

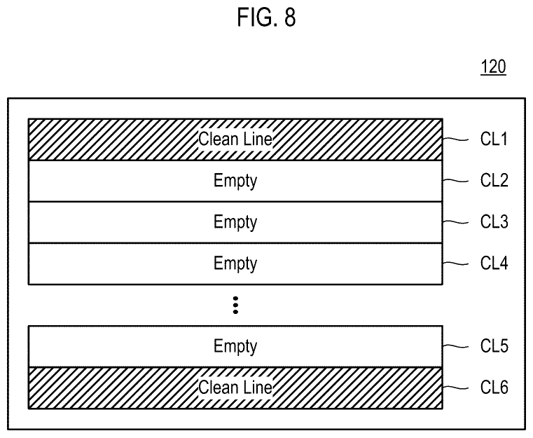

FIGS. 7 and 8 are diagram illustrating an operation based on indicator information for invalidation according to example embodiments. FIGS. 7 and 8 illustrate a state after the third cache line CL3 is rendered empty according to FIGS. 5 and 6.

Referring to FIG. 7, an example is provided where data stored in the second cache line CL2 is updated or modified useless data. In this case, the second cache line CL2 may be storing useless data in a dirty state. For example, the first memory 120 is aware that the data stored in the second cache line CL2 is useless when a request for the writeback of the second cache line CL2 is received. Therefore, writeback should be performed. As a result, the processor may transmit indicator information INV_REQ about a corresponding cache line to the first memory 120 regardless of the state of the dirty bit when the data is confirmed to be useless.

Similarly, the indicator information INV_REQ may be set a valid bit of a cache line including the useless data to logic low to indicate that it is invalid. The indicator information INV_REQ may allow the first memory 120 to exclude data and a tag address, stored in the second cache line CL2, from its management scope. When the second cache line CL2 is invalidated, the second cache line CL2 may be rendered empty as illustrated in FIG. 8. For example, the first memory 120 may remove the data, stored in the second cache line CL2 associated with the indicator information INV_REQ, to render the second cache line CL2 empty. As a result, among a plurality of cache lines included in the first memory 120, the second cache line CL2 and the third cache line CL3, which originally included useless data, may be rendered empty based on the indicator information INV_REQ.

Referring to FIGS. 5 to 8, by using the indicator information INV_REQ to render a memory area, where useless data is stored, empty, the first memory 120 can prevent a situation where a writeback request for that specific memory area is received. The invalidation may allow the electronic device to invalidate a memory area without setting a dirty bit (dirty or clean) for the memory area such as a cache line. Accordingly, the first memory 120 may skip a writeback for useless data.

According to the above-described embodiments, the electronic device may reduce a performance burden of the first memory 120, which is hardware, by notifying the first memory 120 of a memory area, where useless data is stored, with the indicator information INV_REQ. In addition, a writeback for useless data may be skipped by transmitting the indicator information INV_REQ, requesting invalidation of a memory area corresponding to the useless data. Therefore, the example embodiments may be implemented without changing or modifying a structure of the cache entry (for example, FIG. 3).

In addition, the electronic device may rapidly secure a free space in the first memory 120 through an invalidation command, and thus, security may be enhanced since another processor (or core) cannot read a changed value before invalidation.

### Dirty Bit Clear

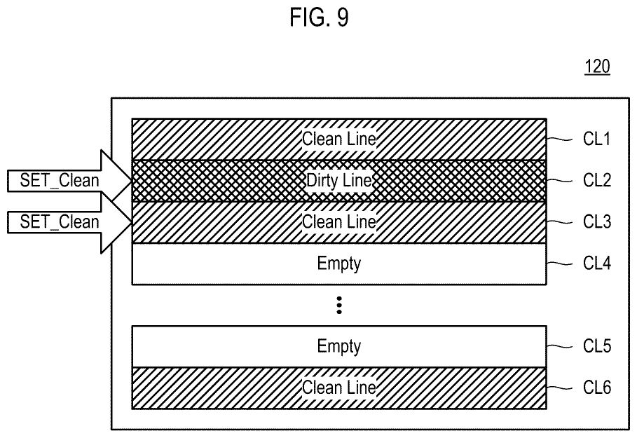

FIGS. 9 to 11 are diagrams illustrating an operation based on indicator information for clearing dirty bits according to example embodiments.

Referring to FIG. 9, an example is provided where data stored in the second and third cache lines CL2 and CL3 is updated or modified useless data. In this case, when a request Flush_REQ requires a writeback of the second and third cache lines CL2 and CL3, the first memory 120 may also perform a writeback of the second cache line CL2 in a dirty state.

Accordingly, the processor may transmit indicator information SET_Clean on the second and third cache lines CL2 and CL3, where useless data is stored, to the first memory 120. In this case, the indicator information SET_Clean may be used to set dirty bits, included in one or more memory areas, to logic low, thereby indicating that data stored in the one or more memory areas has not been modified. For example, the indicator information SET_Clean may be used to set a cache line, where the useless data is stored, to a clean state by clearing dirty bits included in the cache line.

In addition, the processor is not aware of a dirty or clean state of the data stored in the first memory 120. Therefore, when data is confirmed to be useless, the processor may transmit the indicator information SET_Clean about the corresponding cache line to the first memory 120 regardless of a state of the dirty bit, for example, regardless of whether the useless data has been modified or not.

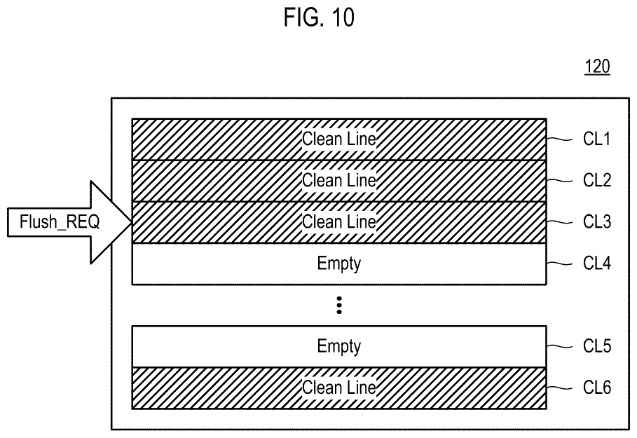

The dirty bits included in the second and third cache lines CL2 and CL3 may be set to logic low based on the indicator information SET_Clean to represent a clean state, as illustrated in FIG. 10. In this case, even if the useless data stored in the second cache line CL2 has been updated or modified, it may be treated as being in a clean state based on the indicator information SET_Clean.

Then, the request Flush_REQ requiring writeback for the third cache line CL3 may be transmitted from the processor, as illustrated in FIG. 10. For example, the request Flush_REQ that requires writeback could include a flush operation to clear a memory area or an eviction operation to remove an existing cache line in order to allocate a new memory area. For example, the flush operation may involve rending a dirty state clean and invalidating the cache line. Additionally, both flush and eviction operation may require writeback for the main memory to achieve coherence when data stored in the existing memory area is in a dirty state.

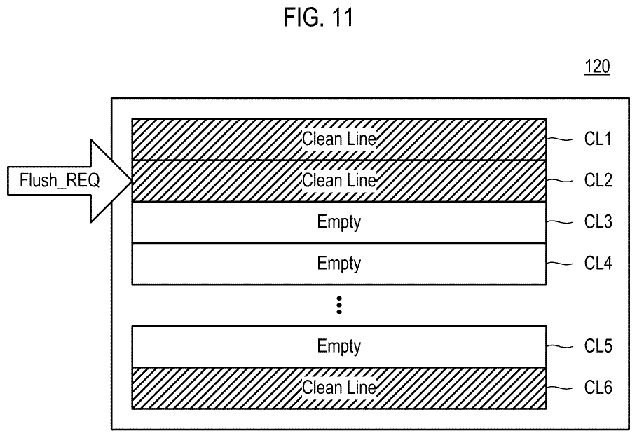

However, since the third cache line CL3 was already in a clean state regardless of the indicator information SET_Clean, the first memory 120 does not perform writeback on the data stored in the third cache line CL3 in response to the flush request Flush_REQ for the third cache line CL3. Since the flush request Flush_REQ involves a clear operation based on invalidation, the first memory 120 may clear the third cache line CL3 to be rendered empty, as illustrated in FIG. 11.

Then, the request Flush_REQ for writeback may also be transmitted from the processor to the second cache line CL2, as illustrated in FIG. 11. Although an existing second cache line CL2 was in a dirty state, it may be changed to a clean state by setting a dirty bit to logic low by using the indicator information SET_Clean. Accordingly, the first memory 120 receives the request Flush_REQ for the second cache line CL2, but since the cache line has already been changed to the clean state, the writeback may be skipped and the second cache line CL2 may be rendered empty.

For example, when the first memory 120 receives the request Flush_REQ to perform a writeback for one or more memory areas, where useless data is stored, from the processor, the first memory 120 may skip the writeback operation for the request Flush_REQ and clear one or more memory areas based on the dirty bit being set to logic low. Additionally, the clearing of the memory areas may also be understood as performing an eviction to remove data from a clean memory area.

According to the above-described embodiments, the electronic device may notify the first memory 120 of a memory area, where useless data is stored, through indicator information SET_Clean to skip a writeback even when the useless data is not modified or is in an updated or modified state. The electronic device may avoid an unnecessary writeback by setting the dirty bit of the memory area, where the useless data is stored, to clean. Thus, the memory area is considered to be in the clean state even for requests requiring a writeback for the memory area, such as an eviction or flush in which the memory area is sacrificed. As a result, a performance burden of the first memory 120, which is hardware, may be reduced.

In addition, example embodiments may be implemented without changing the structure of the cache entry (for example, FIG. 3). In addition, even when the dirty bit is set to a clean state through the indicator information SET_Clean, the memory area (for example, a cache line) is still present. Therefore, memory reallocation may not be required. As a result, latency may be reduced when a physical address included in the memory area is used.

Alternatively, in the above-described example embodiments, when a write access to a memory area is required after a dirty bit is changed to a clean state (for example, logic low), the electronic device may reset the dirty bit back to logic high before the write access is permitted. The electronic device may reset the dirty bit to logic high during a write access to prepare for the situation where the memory area will be reallocated and reused. When the dirty bit is in a logic high state and a normal write access operation is performed, data written may be considered to be clean even if new data has been written instead of useless data. Accordingly, the electronic device may set the dirty bit to logic low in advance to prevent a coherence issue from occurring in the future.

Alternatively, according to above-described example embodiment, the indicator information SET_Clean may be implemented in the form of a cache maintenance instruction configured to transmit information on an address of useless data.

### Addition of Useless Bit

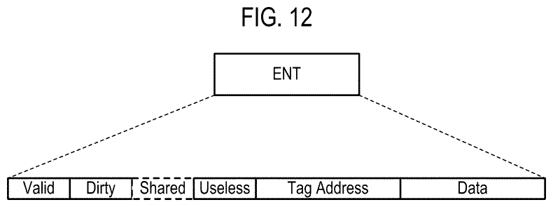

FIG. 12 is a diagram illustrating a first memory according to example embodiments.

Referring to FIG. 12, a first memory 120 may further include a useless bit, in addition to the valid bit, the dirty bit, the shared bit, the tag address bit, and the data field included in the cache entry ENT of FIG. 3.

The useless bit may indicate whether data stored in each of a plurality of memory areas is useless data. For example, when the useless bit is set to logic high, it may indicate that the data stored in the memory area is useless. In addition, when the useless bit is set to logic low, it may indicate that the stored data is not useless. For example, the useless bit may indicate that data of a specific tag address is useless.

When the useless bit is set to logic high, the memory area may be excluded from a management or coherency requirement target.

In example embodiments, when an access operation is performed on a memory area including a useless bit, a normal access operation may be performed when the useless bit is set to logic low. The normal access operation may refer to an operation required for access being performed, without any additional operations being performed when the useless bit is set to logic high.

When the useless bit is set to logic high, an access operation to a corresponding memory area may include either an operation of clearing a useless bit (for example, setting the useless bit to logic low) or an operation of invalidating the corresponding memory area.

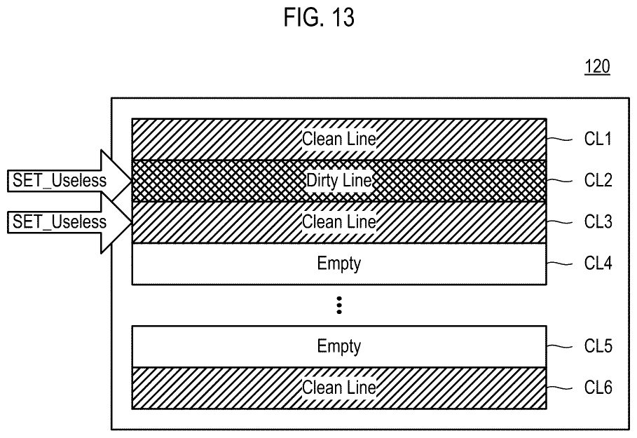

FIGS. 13 to 16 are diagrams illustrating an operation based on indicator information for setting a useless bit according to example embodiments.

Referring to FIG. 13, an example is provided where data stored in the second and third cache lines CL2 and CL3 is updated or modified to become useless data. In this case, a processor may transmit indicator information SET_Useless about the second and third cache lines CL2 and CL3, where the useless data is stored, to the first memory 120. The indicator information SET_Useless may be used to set a useless bit in one or more memory areas to logic high to indicate that the data stored in one or more memory areas is useless. For example, the indicator information SET_Useless may set a useless bit, included in a cache line, to logic high to indicate that data stored in the cache line, where the useless data is stored, is useless.

For example, in the case of FIG. 13, the indicator information SET_Useless may be used to set useless bits, included in the second and third cache lines CL2 and CL3, to logic high. In addition, as described above, the processor may transmit the indicator information SET_Useless about the cache line when the cache line is confirmed to include useless data, regardless of a state of the dirty bit.

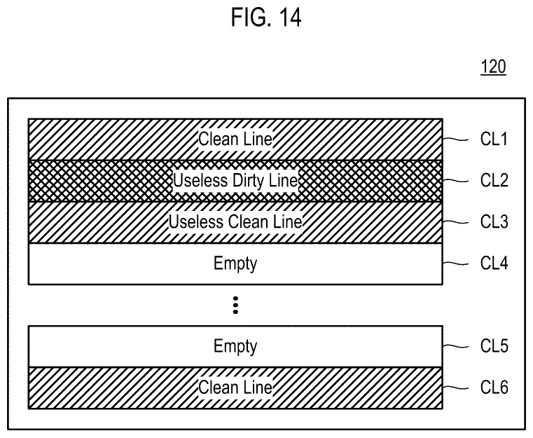

Through the indicator information SET_Useless, the useless bits included in the second and third cache lines CL2 and CL3 may be set to logic high to indicate that the useless bits are all in a useless state, as illustrated in FIG. 14. When the useless bit is set to logic high, it confirms that data stored in each cache line is in a useless state, regardless of the state of the dirty bit of the second and third cache lines CL2 and CL3 (e.g., logic high in the case of the second cache line CL2 and logic low in the case of the third cache line CL3).

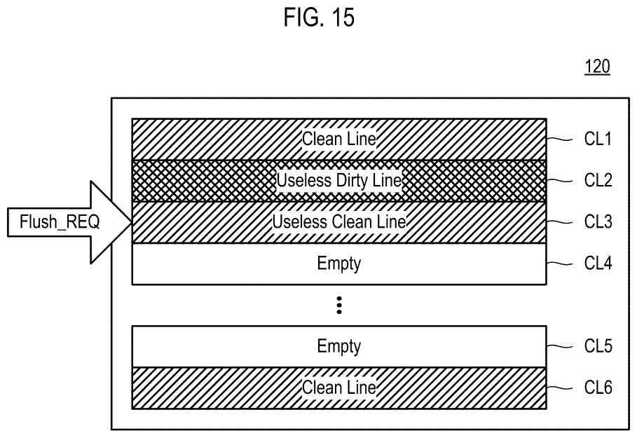

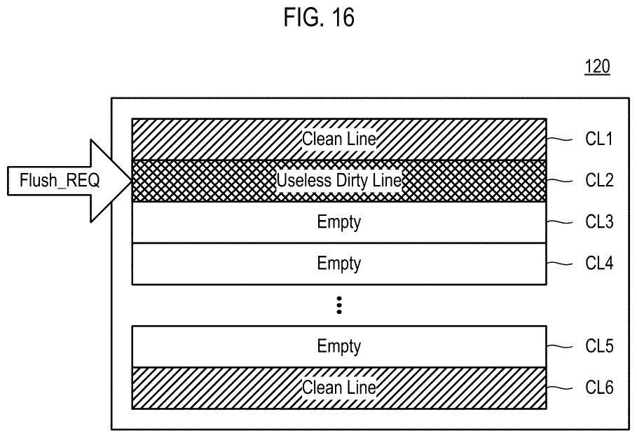

Subsequently, a request Flush_REQ requiring writeback for the third cache line CL3 may be transmitted from the processor, as illustrated in FIG. 15. For example, the request Flush_REQ may be a flush or an eviction, as illustrated. Since the third cache line CL3 was already in a clean state, independent of the indicator information SET_Useless, the first memory 120 does not perform a writeback on the data stored in the third cache line CL3, even when it receives the request Flush_REQ for the third cache line CL3. The flush request Flush_REQ involves a clear operation due to invalidation, allowing the first memory 120 to clear the third cache line CL3, rendering it empty, as illustrated in FIG. 16.

Subsequently, the request Flush_REQ requiring writeback for the second cache line CL2 may be transmitted from the processor. An existing second cache line CL2, which is in a dirty state, may indicate the presence of useless data by setting the useless bit to logic high through the indicator information SET_Useless.

The first memory 120 may clear one or more memory areas without performing a writeback even when it receives a request Flush_REQ requiring a writeback for one or more memory areas (for example, the second cache line CL2 of FIG. 16) where the useless bit is set to logic high. For example, the first memory 120 may clear one or more memory areas without performing a writeback when the useless bit is set to logic high. For example, the first memory 120 may receive a flush request Flush_REQ for the second cache line CL2, but may skip the writeback and render the second cache line CL2 empty after confirming that the second cache line CL2 already stores useless data.

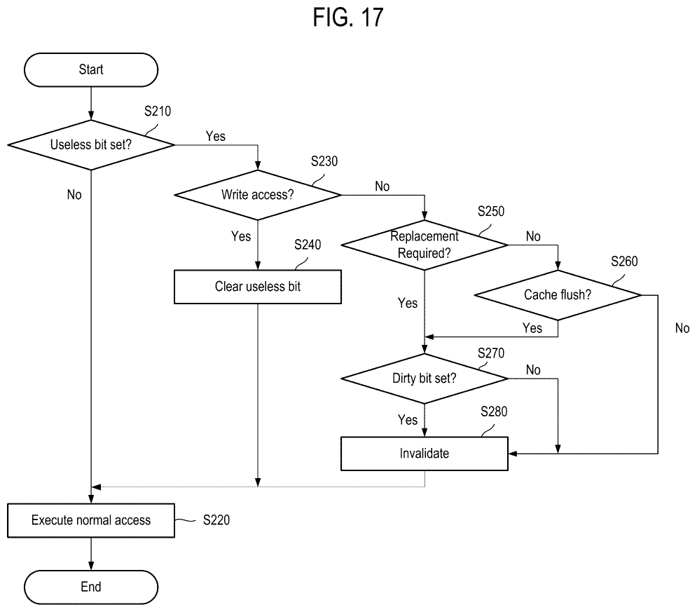

FIG. 17 is a flowchart illustrating a method of operating an electronic device according to example embodiments.

Referring to FIG. 17, in operation S210, an electronic device may determine whether a useless bit is set in a memory area. For example, the electronic device may determine whether the useless bit is logic high. For example, when the useless bit is logic high, the electronic device may determine that data stored in the memory area is useless data. When the useless bit is logic low, for example, the data stored in the memory area is not useless, and thus, the flow proceeds to operation S220. In operation S220, the electronic device may perform a normal access operation.

When it is confirmed that the useless bit is logic high in operation S210, the flow proceeds to operation S230. In operation S230, the electronic device may check whether the access is a write access. For example, the electronic device may determine whether an access to one or more memory areas is a write access, based on the useless bit being logic high. When it is confirmed that the access is a write access, the flow proceeds to operation S240. In operation S240, the electronic device may clear the useless bit. For example, based on the useless bit being logic high and a write access operation being performed on the one or more memory areas, the electronic device may change the useless bit to logic low to indicate that data stored in each of a plurality of memory areas is not useless data.

Then, in operation S220, the electronic device may perform a normal access operation.

According to the above-described embodiments, when the access is a write access, the electronic device may clear the useless bit to prepare for the case where the memory area is reallocated and reused. When a normal access operation is performed while the useless bit is logic high, written data may be considered to be useless data even if new data is written. Accordingly, the electronic device may clear the useless bit in advance to prevent a coherency issue from occurring in the future.

When it is confirmed that the access is a read access in operation S230, the flow proceeds to operation S250. In operation S250, the electronic device may determine whether replacement is required. Requiring replacement may mean that an existing memory space is removed to secure a new memory space for a cache memory. In other words, requiring replacement indicates that an existing memory space must be cleared to accommodate a new memory space in cache memory. For example, requiring replacement may mean that the above-described eviction operation is required.

When it is determined that replacement is not required, for example, when the read access does not involve eviction, the electronic device may determine whether flushing has been requested in operation S260. For example, the electronic device may determine whether the read access involves flushing.

To summarize operations S250 to S260, the electronic device may determine whether the read access involves eviction or flushing, when the access is a read access.

Alternatively, to summarize operations S210, S230, and S250 to S260, the electronic device may determine whether the read access involves eviction or flushing, by checking if the useless bit is set to logic high and the read access is conducted on one or more memory areas.

When it is determined that replacement is required in operation S250 or it is determined that flushing is required in operation S260, the flow proceeds to operation S270. In operation S270, the electronic device may determine whether a dirty bit is set. When the dirty bit is set to logic high, the flow proceeds to operation S280. In operation S280, the electronic device may invalidate the corresponding memory area.

To summarize operations S250 to S270, the electronic device may determine if the dirty bit is set to logic high, indicating that the data stored in the one or more memory areas has been modified, when the read access involves eviction or flushing. When the read access involves eviction or flushing and the dirty bit is set to logic high, indicating that the data stored in the one or more memory areas has been changed, the electronic device may set a valid bit to logic low to indicate that the one or more memory areas are invalid.

According to the above-described embodiments, the electronic device may inform the first memory about the memory area containing the useless data through the indicator information. This allows the system to skip the writeback process for the useless data, regardless of whether it is not modified or has been modified or updated.

For example, in the case where a useless bit is added, a normal access operation may be performed when the useless bit is cleared to logic low. Therefore, an operation associated with useless data, including writeback skipping, may be easily enabled and disabled. In addition, the corresponding memory area (for example, cache line) is still present regardless of the useless bit, so that memory reallocation is not required. Thus, latency may be reduced when a physical address included in the corresponding memory area is used.

The indicator information according to the above-described example embodiment may be implemented in the form of a cache maintenance instruction configured to transmit information on an address of the useless data. For example, similar to Data Cache Zero by Virtual Address (DC ZVA) that is an instruction to initialize data in a memory area location, indicated by a virtual address, to zero, the indicator information may be implemented as an instruction that sets data in a memory area location, indicated by a virtual address, as useless data.

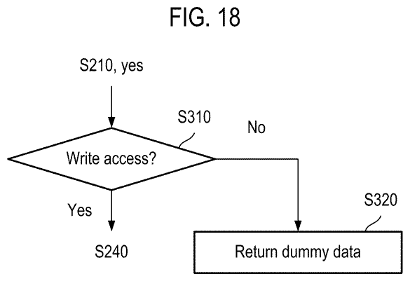

FIG. 18 is a flowchart illustrating a method of operating an electronic device according to example embodiments.

Referring to FIG. 18, in operation S310, the electronic device may determine whether the access to the one or more memory areas is a write access. Operation S310 may be performed when it is determined that the useless bit is set to logic high, through operation S210 of FIG. 17.

When the access is a write access, the flow proceeds to operation S240 of FIG. 17. When the access is a read access, the flow proceeds to operation S320. In this case, the electronic device may provide dummy data in response to the read access. For example, the electronic device may identify a read access to a memory area with the useless bit set to logic high as an abnormal access and consequently return dummy data. The above-described operation is performed because the read access occurs even after the processor has already determined that the corresponding memory area contains useless data in software, which could pose a security issue. According to the above-described embodiments, security against a spectre attack such as intruder attack may be enhanced.

### Addition of Register

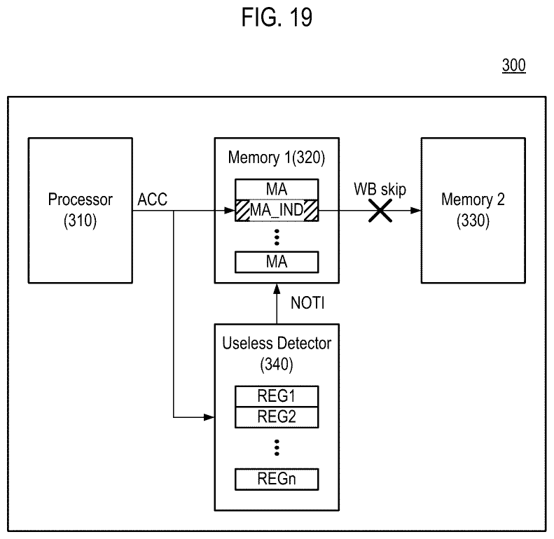

FIG. 19 is a diagram illustrating an electronic device according to example embodiments.

Referring to FIG. 19, an electronic device 300 according to example embodiments may further include a useless data detector 340, in addition to a processor 310, a first memory 320, and a second memory 330, like those shown in FIG. 1.

The useless data detector 340 may be configured to determine whether an access ACC from the processor 310 is associated with useless data. The useless data detector 340 may include a plurality of registers REG1 to REGn. Each of the plurality of registers REG1 to REGn may store data, such as an address value for useless data, to indicate whether the specific access ACC is an access to the useless data.

The useless data detector 340 may determine whether the access ACC is associated with useless data, based on comparing a register associated with the useless data and an address of an access ACC provided from the processor 310 to the first memory 320. For example, the useless data detector 340 may intercept the access ACC from the processor 310 to determine whether a register corresponding to the address of the access ACC is present. When the corresponding register is present, the useless data detector 340 may determine the access ACC to be an access to useless data.

When it is determined that the access ACC is an access to useless data, the useless data detector 340 may transmit a notification NOTI to the first memory 320 to notify the first memory 320 that the access ACC is an access to the useless data. Through the notification NOTI, the first memory 320 may confirm that data stored in one or more memory areas MA_IND, among a plurality of memory areas MA, is useless data. The first memory 320 may skip a writeback even when an access ACC to the one or more memory areas MA_IND involves the writeback.

According to the above-described embodiments, when the first memory 320 is a cache memory, the electronic device 300 may notify the first memory 320 that the data is useless data, through the useless data detector 340, which is hardware, while maintaining a structure of a cache memory or a command for the cache memory.

As set forth above, according to example embodiments, an electronic device supporting writeback skipping and a method of operating the same are provided.

While example embodiments have been shown and described above, it will be apparent to those skilled in the art that modifications and variations could be made thereto without departing from the scope of the present inventive concept as set forth in the appended claims.

What is claimed is:

1. An electronic device comprising:
a memory; and
a processor connected to the memory and configured to execute at least one instruction,
wherein
the processor executes the at least one instruction to transmit indicator information to the memory, wherein the indicator information identifies one or more memory areas, among a plurality of memory areas included in the memory, where useless data is stored, and
the memory skips a writeback for the one or more memory areas, in response to the indicator information.

2. The electronic device of claim 1, wherein
each of the plurality of memory areas comprises a valid bit and a dirty bit, wherein the valid bit indicates if the memory area is valid, and the dirty bit indicates if data stored in the memory area has been modified.

3. The electronic device of claim 2, wherein
the indicator information is used to set the valid bit, included in at least one of the memory areas, to logic low to indicate that the at least one memory area is invalid.

4. The electronic device of claim 2, wherein
the indicator information is used to set the dirty bit, included in at least one of the memory areas, to logic low to indicate that the data stored in the at least one memory area is not modified.

5. The electronic device of claim 4, wherein
the memory is configured to:
receive a request that requires the writeback for the at least one memory area from the processor; and
skip the writeback that was requested and clear the at least one memory area, when the dirty bit is logic low.

6. The electronic device of claim 5, wherein
the useless data is modified or unmodified data.

7. The electronic device of claim 2, wherein
each of the plurality of memory areas further comprises a useless bit indicating whether the data stored in each of the plurality of memory areas is the useless data.

8. The electronic device of claim 7, wherein
the indicator information is used to set the useless bit, included in at least one of the memory areas, to logic high to indicate that the data stored in the at least one memory area is the useless data.

9. The electronic device of claim 8, wherein
the memory is configured to:
receive a request that requires the writeback for the at least one memory area from the processor; and
skip the writeback that was requested and clear the at least one memory area, when the useless bit is logic high.

10. The electronic device of claim 8, wherein
the processor executes the at least one instruction to set the useless bit to logic low to indicate that the data stored in each of the plurality of memory areas is not the useless data, when the useless bit is set to logic high and a write access to the at least one memory area is being performed.

11. The electronic device of claim 8, wherein
the processor executes the at least one instruction to determine whether the read access requires eviction or flushing, when the useless bit is set to logic high and a read access to the at least one memory area is being performed.

12. The electronic device of claim 11, wherein
the processor executes the at least one instruction to set the valid bit to logic low to indicate that the at least one memory area is invalid, in response to the read access that requires the eviction or the flushing and the dirty bit is set to logic high.

13. The electronic device of claim 1, further comprising:
a useless data detector configured to determine whether an access to the memory is associated with the useless data, by comparing a register associated with the useless data and an address of the access to the memory.

14. The electronic device of claim 1, wherein
the useless data is data based on a dynamic allocation of the one or more memory areas after being released.

15. A method of operating an electronic device, the method comprising:
checking whether data stored in one or more memory areas, among a plurality of memory areas included in a memory, is useless data; and
transmitting indication information associated with the one or more memory areas to the memory, based on the checking of the useless data,
wherein
the indicator information is used to skip a writeback for the one or more memory areas.

16. The method of claim 15, wherein
each of the plurality of memory areas comprises at least one of a valid bit, a dirty bit and a useless bit, wherein the valid bit indicates whether the memory area is valid, the dirty bit indicates whether data stored in the memory area has been modified, and the useless bit indicates whether the data stored in the memory area is the useless data.

17. The method of claim 16, wherein
the indicator information is used to set the useless bit, included in at least one of the memory area, to logic high to indicate that the data stored in the at least one memory area is the useless data.

18. The method of claim 17, further comprising:
determining whether the useless data is logic high;
determining whether an access to the at least one memory area is a write access, when the useless data is logic high; and
determining whether a write access requires eviction or flushing, when the access is the write access.

19. The method of claim 18, further comprising:
determining whether the dirty bit is set to logic high to indicate that the data stored in the at least one memory area has been modified, in response to a read access that requires the eviction or the flushing; and
setting the valid bit to logic low to indicate that the at least one memory area is invalid, when the dirty bit is set to logic high.

20. An electronic device comprising:
a first memory;
a processor connected to the first memory and configured to execute at least one instruction; and
a second memory,
wherein
the processor executes the at least one instruction to transmit indicator information to the memory, wherein the indicator information identifies one or more memory areas, among a plurality of memory areas included in the first memory, where useless data is stored, and
the first memory skips a writeback to the second memory from the one or more memory areas, in response to the indication information.
